(19) United States
(12) Patent Application Publication
(10) Pub. No.: US 2023/0218463 A1
(43) Pub. Date: Jul. 13, 2023

(54) Containment, Treatment, and Removal of Aerosolized Viral Contamination

(71) Applicants: NEW YORK UNIVERSITY, New York, NY (US); AERAGEN, INC., Brooklyn, NY (US)

(72) Inventors: Vikram Kapila, West Orange, NJ (US); Valentin SIDERSKIY, Bellingham, MA (US); Armando GRANADO, Brooklyn, NY (US); Sahil KUMAR, Brooklyn, NY (US); Tom Sowers, Pequea, PA (US); Hassam Khan WAZIR, New York, NY (US); Miles Quinn KILCOURSE, Westlake Village, CA (US); Sai Prasanth KRISHNAMOOTHY, Princeton, NJ (US); Ryan GONZALEZ, Chatham, NJ (US)

(21) Appl. No.: 18/002,125

(22) PCT Filed: Jun. 17, 2021
(86) PCT No.: PCT/US21/37861

§ 371 Date: Dec. 16, 2022

Related U.S. Application Data
(60) Provisional application No. 63/040,203, filed on Jun. 17, 2020.
(60) Provisional application No. 63/151,283, filed on Feb. 19, 2021.

(51) Int. Cl. A61G 10/00; B01D 46/44; B08B 15/02; B01D 46/54; B01D 39/20

(52) U.S. Cl. CPC A61G 10/005; B01D 46/44; B08B 15/02; B01D 46/543; B01D 46/546; B01D 39/2062; A61L 2209/14; B01D 2239/0618

(57) ABSTRACT

The present invention provides devices and methods to capture airborne agents, microbes, including viruses, and microbial antigens, toxins and allergens and prevent the spread of infection from direct contact with contaminated surfaces (contact contamination), from large droplets of infectious material that fall out of the air, or from small droplets that can be carried by the air stream throughout the environment (airborne contamination).

### CROSS-REFERENCE TO RELATED APPLICATIONS

This application claims priority to U.S. Provisional Patent Application No. 62/040,203, filed Jun. 17, 2020, and to U.S. Provisional Patent Application No. 63/151,283, filed Feb. 19, 2021, the contents of which are each incorporated by reference herein in their entirety.

### BACKGROUND OF THE INVENTION

Air contamination by airborne microorganisms, including viruses as well as other pathogens and toxins, has resulted in increased morbidity and mortality. This problem is related to the fact that air becomes contaminated with various organisms either through contact with individuals who are infected or with individuals who carry these organisms in their respiratory passages as carriers, on clothing, or through contact of air with such subjects in hospitals, surgeries, wards, nurseries and other areas. Furthermore, it has been found that objects such as bedding, blankets, furniture and the like become carriers through receiving deposited organisms by contact with infected individuals or with contaminated air. This has resulted in the transmission of disease through pathogenic organisms, microorganisms, viruses and the like especially in public buildings, crowded rooms, schools, hospitals, theaters, etc.

Existing hospitals are not well equipped for isolating a subject who has or may have such a disease so as to prevent others from becoming infected. For example, the central heating, ventilating, and air-conditioning (H.V.A.C.) systems of most hospitals are generally not designed to provide individual room negative air pressure. Further, even if such systems were available, they are impractical, highly costly, and cannot be implemented at scale.

Additionally, hospitals are also not currently equipped to maintain containment of an infectious subject during transportation. Hospitals currently rely on procedures such as shutting doors while an infectious subject is being transported and cleaning surfaces afterwards; however, it would be far more effective if hospitals could prevent the spread of contaminants in the first place.

Thus, there is a need in the art for air chambers that effectively isolate infected subjects and reduce the spread of disease, which are readily adjustable, portable, and can be assembled and disassembled within a preexisting structure and adapt to a wide variety of locations. The present invention meets this need.

### SUMMARY OF THE INVENTION

In one aspect, the present invention relates to an air-vent device comprising: a stand extending vertically between a superior end and an inferior end; an enclosure positioned at the superior end of the stand, the enclosure having an interior space bounded by a generally closed top and lateral side and an open bottom side; and a blower having an inlet port and an exhaust port, the inlet port being fluidly connected to the interior space of the enclosure; wherein the blower comprises one or more filters between the inlet port and the exhaust port.

In one embodiment, the stand has an adjustable height. In one embodiment, the enclosure is suspended from a frame extending from the superior end of the stand. In one embodiment, the enclosure is attached to the frame by connectors selected from the group consisting of: rubber rings, ties, clips, cables, rubber bands, hooks, and loops. In one embodiment, the stand comprises wheeled legs at the inferior end. In one embodiment, the stand further comprises a control unit configured to power and operate the blower.

In one embodiment, the blower is configured to move between about 50 cubic feet of air per minute (CFM) to about 150 CFM. In one embodiment, the blower has a fan speed between about 500 revolutions per minute (RPM) and about 5000 RPM. In one embodiment, the one or more filters are selected from the group consisting of: high-efficiency particulate air (“HEPA”) filters, ultra-low particulate air (“ULPA”) filters, activated carbon filters, washable filters, membrane filters, nanospun filters, and non-woven filters.

In one embodiment, the lateral side of the enclosure comprises one or more access slots. In one embodiment, the access slots are slits formed in the enclosure. In one embodiment, the access slots are apertures formed in the enclosure. In one embodiment, each access slot is covered by a flap.

In one embodiment, the enclosure has a height between about 3 feet and about 10 feet. In one embodiment, the enclosure has a width or diameter between about 2 feet and about 6 feet. In one embodiment, the enclosure has a thickness between about 0.001 inches and about 0.024 inches. In one embodiment, the enclosure is constructed from a material selected from the group consisting of: polyvinyl, polyethylene, polyvinylchloride, and polyester. In one embodiment, the enclosure is sized to fit over a width of a hospital bed, a hospital gurney, a hospital stretcher, an ambulance stretcher, a chair, a bench, a wheelchair, an operating table, or an instrument tray.

In one aspect, the present invention relates to a method for removing airborne contaminants surrounding a subject comprising the steps of: providing an air-vent device comprising an enclosure defining an interior space and a blower fluidly connected to the interior space; placing a subject within the interior space of the enclosure; extracting air from within the interior space using the blower; passing extracted air through at least one filter in the blower to generate filtered air; and expelling filtered air from the blower exterior to the enclosure.

In one embodiment, the subject is positioned such that aerosols and particulates associated with breathing, talking, speaking, singing, coughing, or sneezing are exhaled or expelled within the interior space of the enclosure.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1 depicts a side view of an exemplary air-vent device.

FIG. 2 depicts a diagram of an exemplary air-vent device.

FIG. 3 depicts a diagram of a curtain of an exemplary air-vent device.

FIG. 4 depicts prototype air-vent devices.

FIG. 5 depicts a perspective view of an exemplary air-vent device.

FIG. 6 depicts a side view of an exemplary air-vent device.

FIG. 7 depicts a perspective view of an exemplary air-vent device.

FIG. 8 depicts a back view of an exemplary air-vent device.

FIG. 9 is a flowchart depicting an exemplary method of using an air-vent device of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in the field of confinement apparatus. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

### Definitions

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, exemplary materials and methods are described herein. In describing and claiming the present invention, the following terminology will be used.

It is also to be understood that the terminology used herein is for the purpose of describing particular embodiments only, and is not intended to be limiting.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate.

The terms “patient,” “subject,” “individual,” and the like are used interchangeably herein, and refer to any animal amenable to the systems, devices, and methods described herein. The patient, subject or individual may be a mammal, and in some instances, a human.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Air-Vent Device

The present invention provides devices and methods to capture airborne agents, including microbes, viruses, bacteria, toxins and allergens, and prevent the spread of infection from direct contact with contaminated surfaces (contact contamination), from large droplets of infectious material that fall out of the air, or from small droplets that can be carried by the air stream throughout the environment (airborne contamination). In one embodiment, the device of present invention can be placed in waiting rooms, exam rooms, surgical suites, hospital rooms, emergency rooms, triage rooms, emergency department rooms, ambulances, intensive care units (“ICUs”), hallways, etc. In some embodiments, the device of present invention can be installed in non-health care settings, including but not limited to restaurants, offices, theaters, etc.

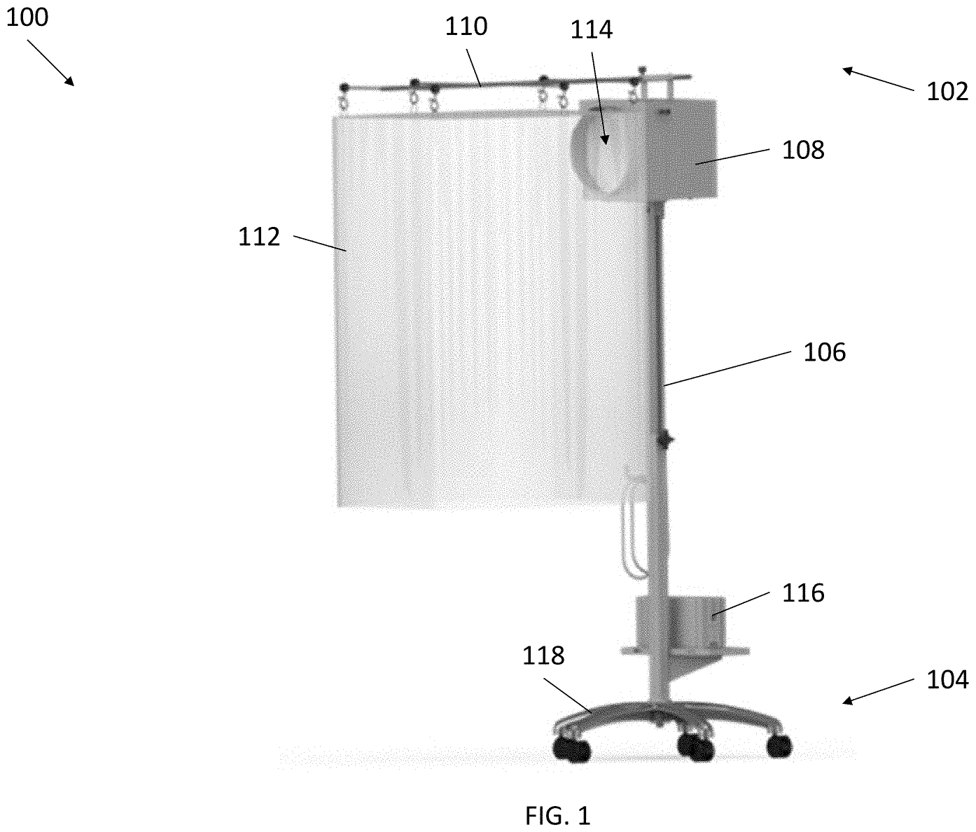

Referring now to FIG. 1, an exemplary air-vent device 100 is depicted. Air-vent device 100 comprises an enclosure that is closed on top and lateral sides and is open on a bottom side to define a three-dimensional interior space, in which a negative pressure environment is mimicked within the interior space by extracting air from the interior space using a blower, filtering the air, and expelling the filtered air into the surrounding environment. Due to a pressure differential, a flow of air from the surrounding environment circulates into the interior space through the open bottom. Device 100 comprises a stand 106 extending between a superior end 102 and an inferior end 104. Stand 106 can be telescoping and has an adjustable height, using a spring, gas, hydraulic, or electronically assisted means of height adjustment. An instant height can be reversibly locked using a knob or switch.

At superior end 102, device 100 comprises a blower 108 and a frame 110 extending laterally from which an enclosure formed by curtain 112 is suspended. In some embodiments, one or more additional stands 106 and/or frames 110 can be linked together to support one or more curtains 112. Curtain 112 defines a three-dimensional interior space that is generally closed on a top side and lateral sides with an opening at a bottom side. Blower 108 is fluidly connected to the interior space of curtain 112 by an inlet port 114, wherein air is drawn in. Blower 108 comprises one or more exhaust ports for expelling filtered air (not pictured). Blower 108 further comprises one or more filters positioned between inlet port 114 and the exhaust ports, as will be described elsewhere herein.

At inferior end 104, device 100 comprises a base 118. Base 118 can include weighted legs configured to stably position device 100 in a vertical orientation. Base 118 can further include wheeled legs having lockable casters to facilitate transport of device 100. In some embodiments, device 100 can attach to a bed, gurney, stretcher, or a wheelchair, such that curtain 112 partially or completely covers the structure that device 100 is attached to. Device 100 can also be mounted to a wall, ceiling, or vehicle. In some embodiments, device 100 can further comprise a control unit 116, wherein control unit 116 can be configured to provide power to blower 108 and to operate blower 108. Operation of blower 108 can include increasing fan speed, decreasing fan speed, setting a timer for duration, measuring total operating time, and tracking filter type and filter life. Control unit 116 can be configured to connect to an external source of power, such as an outlet, or configured to accept a portable supply of power such as a battery. In some embodiments, an uninterruptible power supply may be attached to control unit 116, such that device 100 may operate without being plugged into an outlet or operate continually in the event external power is lost or unavailable to prevent breaches of containment. In one embodiment, the battery includes a microprocessor to monitor the amount of battery power remaining and to generate data indicative of the amount of battery power remaining, including an audible and/or visible alarm when the remaining batter power falls below a predetermined level (e.g., about 10 to 20 minutes of remaining power at then current power usage levels). In another embodiment, blower 108 can be powered by an airflow-powered DC electrical generator. In yet another embodiment, blower 108 may comprise an AC motor such that it runs directly form AC power. In various embodiments, device 100 can further comprise holders, hangers, or reels for storing cabling, tubing, additional curtains 112, and the like.

Blower 108 can include but is not limited to a direct drive, forward curve centrifugal-type fan and a motor. In some embodiments, blower 108 is configured to move up to from about 50 cubic feet of air per minute (CFM) to about 150 CFM, such as about 110 CFM. Blower 108 can have a diameter of between about 2.5 inches to about 12 inches, such as about 8 inches, and a length of between about 1 inch to about 10 inches. In some embodiments, blower 108 has a fan speed between approximately 500 revolutions per minute (“RPM”) and 5000 RPM, such as about 3200 RPM. In some embodiments, blower 108 can be driven between about 1/100 to 1/40 horsepower, such as about 1/70 horsepower.

Blower 108 is configured to receive one or more filters. The filters can be removed and replaced, and can be inserted by opening a panel in blower 108 or by sliding a filter into a filter slot. The filters can be any suitable filter appropriate for particles in need of filtration. In some embodiments, the filters include high-efficiency particulate air (“HEPA”) filters. In some embodiments, the filters include ultra-low particulate air (“ULPA”) filters, such as from Cambridge Filter Co. (Syracuse, N.Y.) with an efficiency of about 99.999% for particles of 0.12 microns or greater. The filter is primarily responsible for removing the very small particles included in the air flowing there through. In some embodiments, blower 108 contains a prefilter. Such a prefilter may be used to remove larger particles before the air passes through the at least one filter in order to preserve the filtration capacity of the latter.

In one aspect, blower 108 may comprise a single or a combination of filters and not limited to HEPA or other passive filters, activated carbon Filters, washable filters, membrane filters, nanospun filters, non-woven filters, and any other filtration mediums configured to remove particulates, particulates, or other pollutants of different particle sizes and properties. Washable filters have the advantage of a long lifespan that can be renewed by washing or other processing of the filter. Further, washable filters have higher pressure drop, but are balanced by using newer technologies of washable filters. In another embodiment, all these filter cartridges are replaceable.

In one configuration of device 100, the HEPA filter and Activated carbon filter can be packaged as separate filters. Alternatively, they can be packaged as a single filter cartridge that combines the air filtration properties of both. Different combinations of filters are also contemplated within the scope of the present invention. These filters are replaceable within device 100. The HEPA filter and activated carbon filters function to remove different sized particles from the air. HEPA removes larger particulates, while the activated carbon is capable of adsorbing smaller particles including toxic chemical gases, some viruses, bacteria and more.

Different combinations or choices of filter mediums may be designed to be particularly efficient in removing selections of airborne agents, including viruses, and microbial antigens, toxins and allergens. One example may be for health conditions that are commonly triggered by particular airborne agents. Asthma, for instance, may be triggered by particulate matter such as pet dander, or pollen, more than by gaseous matter. Accordingly, a doctor, or consumer may select a filter suited to a particular trigger to symptoms of their ailment. Alternatively, a filter may be designed for a particular environment.

In one embodiment, the activated carbon filters are treated in different ways before use to improve their ability to filter different air pollutants. Different combinations of activated carbons may also be integrated into the filter, to the same effect. One particular example may be for health conditions that are commonly triggered by particular pollutants. Asthma, for instance, may be triggered by particulate matter such as pet dander, or pollen, more than by gaseous matter. Accordingly, a doctor, or consumer may select a filter suited to a particular trigger to symptoms of their ailment.

In one embodiment, blower 108 may further comprise decontamination means such as an ultra-violet (“UV”) source, a disinfecting gas source or any other decontamination means known to one skilled in the art.

In one embodiment, device 100 further comprises at least one sensor to measure a local airflow velocity. In one embodiment, at least one sensor may be positioned to measure the local airflow velocity at a preselected representative point in the inflow of the air. In one embodiment, the at least one sensor can be positioned anywhere within device 100 to measure changes in velocity. In one embodiment, the at least one sensor may comprise a runtime meter. Such runtime indication may allow the at least one filter to be changed or cleaned based on the actual accumulated runtime of operation of device 100 (i.e., time during which air is actually passing through the at least one filter), rather than relying on a calendar period of time.

In one embodiment, device 100 comprises a plurality of alarms configured to indicate when the overall volumetric flow through the device falls below a predetermined safety level. In one embodiment, device 100 further comprises a display unit configured to display data including the overall volumetric flow through the device.

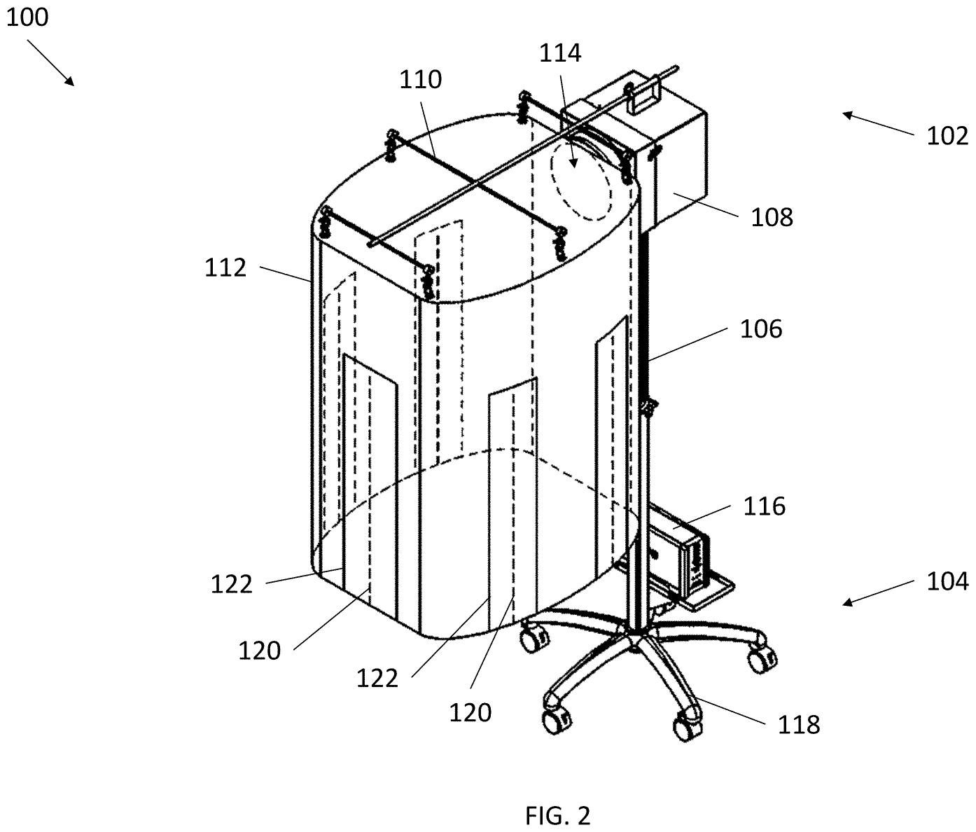

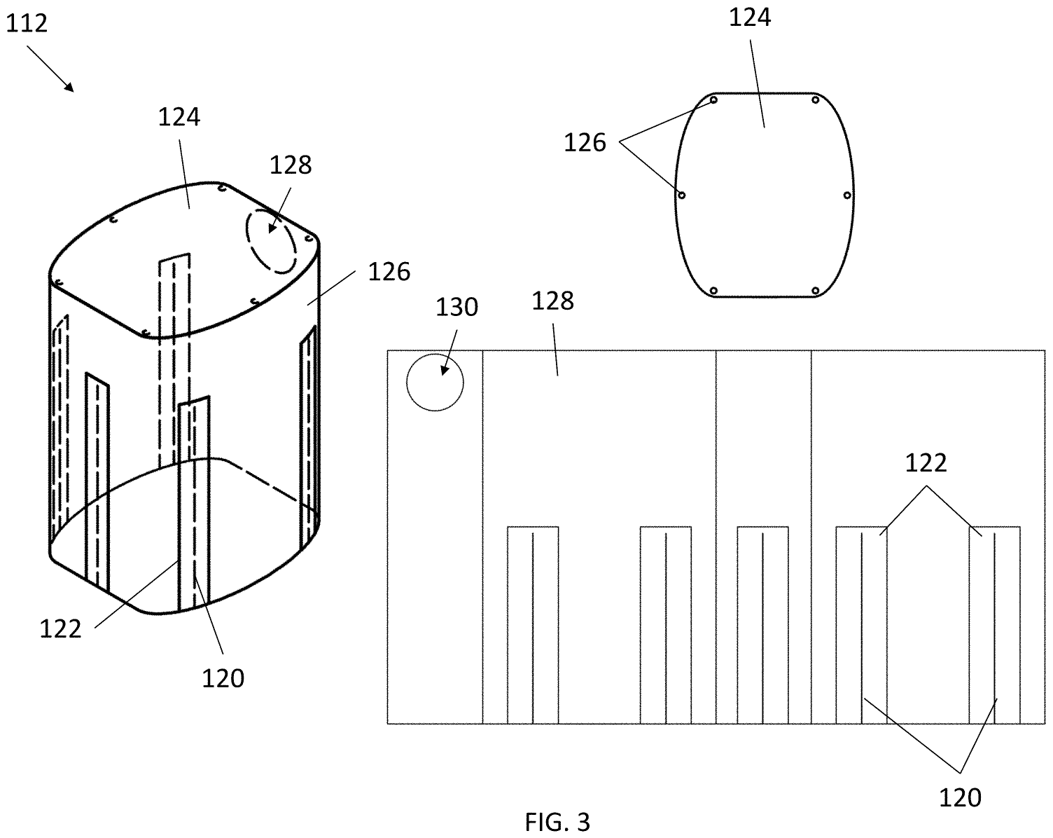

Referring now to FIG. 2 and FIG. 3, curtain 112 is described in detail. Curtain 112 can be formed from fusing a top panel 124 to cover a top side and a side panel 128 to cover lateral sides of a three-dimensional interior space. Top panel 124 can comprise a plurality of anchor points 126 positioned adjacent to or near an outer edge of top panel 124, wherein the plurality of anchor points 126 is configured to connect to frame 110. The connection between anchor points 126 and frame 110 can be any suitable connection. In various non-limiting examples, rubber rings, ties, clips, cables, rubber bands, hooks, loops, and the like can be used to connect an anchor point 126 to frame 110. Side panel 128 comprises an aperture 130 sized to fit port 114 of blower 108.

In some embodiments, the lateral sides comprise one or more access points such that the interior space of curtain 112 is accessible from an exterior of curtain 112. For example, the depicted curtain 112 comprises one or more access slots 120. While each access slot 120 is depicted as extending vertically from an upper end to a lower edge of side panel 128, it should be understood that access slots 120 can be positioned and aligned in any suitable manner on curtain 112. In some embodiments, each access slot 120 can include a fastening mechanism for temporary closing and opening. The fastening mechanism can include but is not limited to: zippers, magnets, snap fasteners, hook and loop fasteners, and the like. In some embodiments, each access slot 120 can be covered by a flap 122, such that an opened or partially opened access slot 120 is not directly exposed to an exterior of curtain 112. Each flap 122 can be sealed against curtain 112 such that flap 122 borders an access slot 120 but does not completely seal it. For instance, a rectangular flap 122 covering an access slot 120 depicted in FIG. 2 and FIG. 3 can be sealed against curtain 112 along one edge, two edges, three edges, or additionally sealed partially along a fourth edge while reserving a nonsealed edge to permit entry into the covered access slot 120.

FIG. 2 and FIG. 3 depict curtain 112 having five access slots 120 positioned on three sides of curtain 112. The positioning of access slots 120 facilitates procedures typical to respiratory illnesses, such as ventilator intubation, bronchoscopy, and other techniques that target a subject's nose, mouth, throat, and lungs. While curtain 112 is shown having five access slots 120 and five rectangular flaps 122, it should be understood that any desired number of access slots 120 and flaps 122 may be provided in any desired position, and that the access slots 120 and flaps 122 may have any desired shape. For example, in addition to slit shapes, access slots 120 may also form rounded or polygonal apertures, and flaps 122 covering the slit shapes and/or apertures may be appropriately shaped to adequately cover the access slots 120.

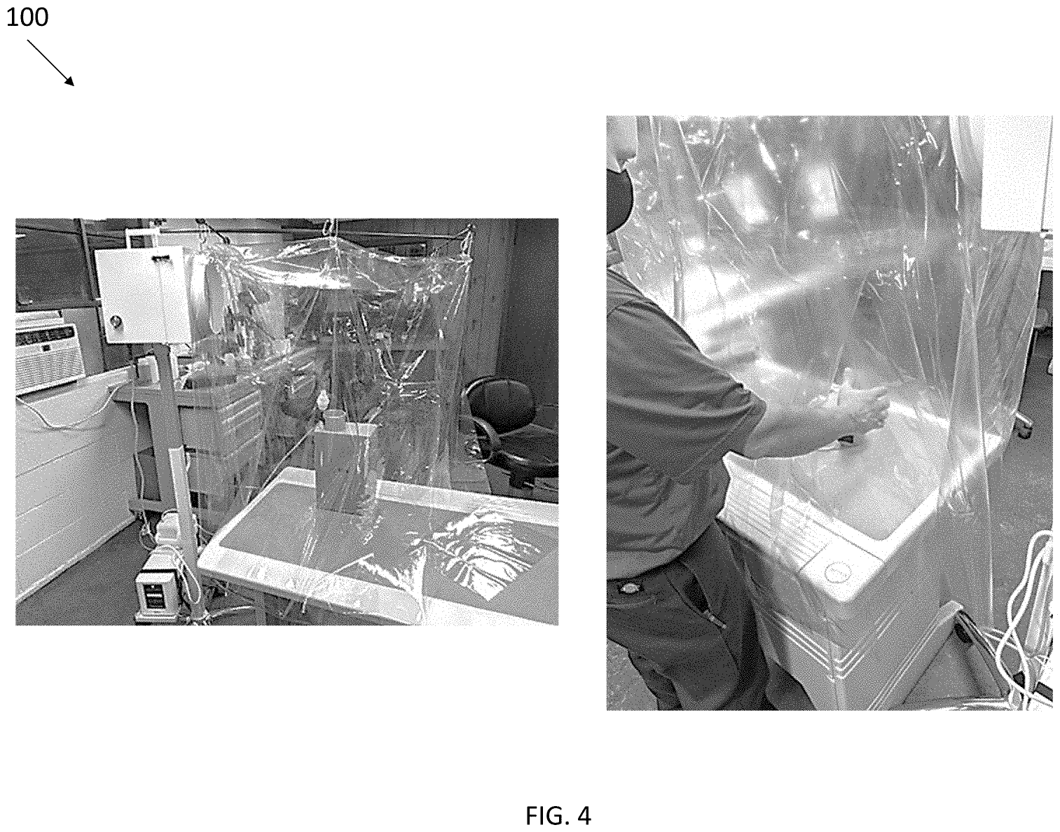

Curtain 112 can have any suitable dimensions. In some embodiments, curtain 112 has a height between about 3 feet and about 10 feet. In some embodiments, curtain 112 has a width or a diameter between about 2 feet and about 6 feet. In some embodiments, curtain 112 is sized to fit over a width of a hospital bed, a hospital gurney, a hospital stretcher, an ambulance stretcher, and the like (FIG. 4, left). In some embodiments, curtain 112 is sized to fit over a chair, a bench, a wheelchair, and the like. In some embodiments, curtain 112 is sized to fit an operating table or instrument tray (FIG. 4, right). Curtain 112 can be constructed from any suitable material, including but not limited to polyvinyl, polyethylene, polyvinylchloride, polyester, and the like. In some embodiments, curtain 112 is at least partially or completely transparent or translucent. In some embodiments, curtain 112 has a thickness between about 0.001 inches and about 0.024 inches. In some embodiments, curtain 112 can comprise one or more coatings in an interior and/or an exterior surface, such as an antiviral coating, antibacterial coating, antimicrobial coating, antifungal coating, and the like.

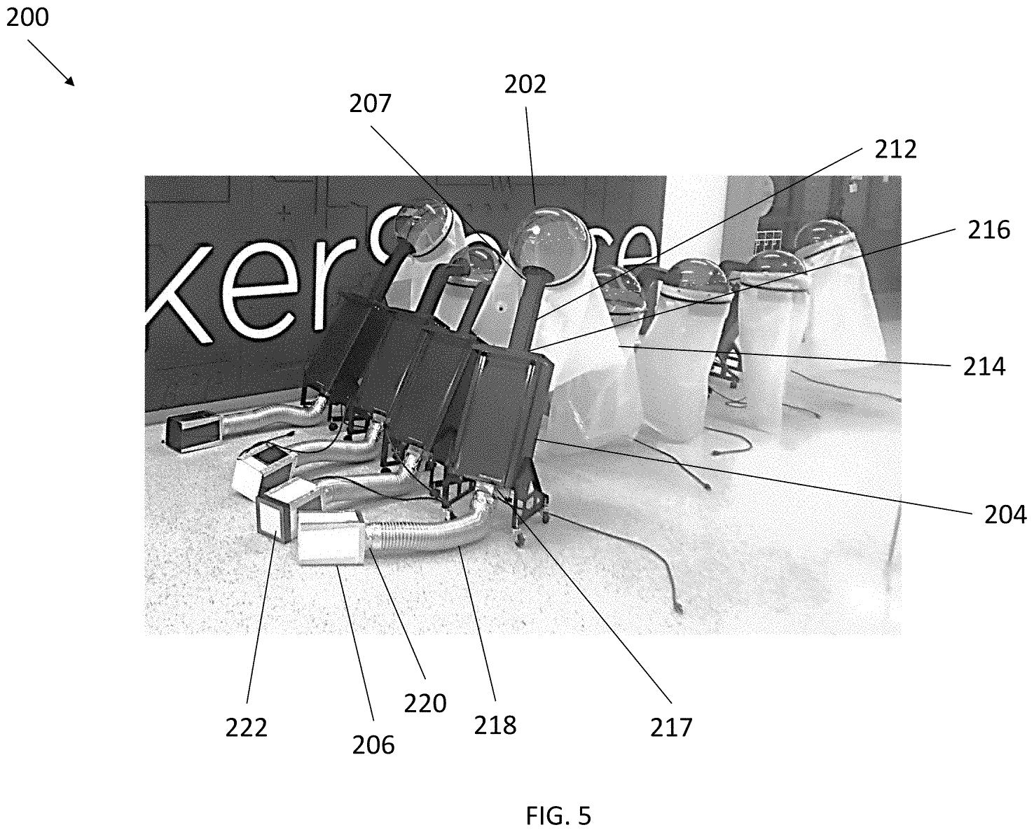

Referring now to FIG. 5, another exemplary air-vent device 200 is depicted. Air-vent device 200 comprises a head unit 202, a base unit 204 and a filter box 206. In one exemplary embodiment, head unit 202 comprises a proximal end 203, a distal end 205 and a first opening 207. In one embodiment, head unit 202 has an ellipsoidal shape radially extending to define a head receiving opening 208. In one embodiment, head unit 202 may have any other appropriate shape including but not limited to an oxygen tent style encasement having a rectangular shape. In one embodiment, head unit 202 is sized to fit over the head of at least one subject. Head unit 202 comprises a first opening 207 at distal end 205 that is fluidly connected to base unit 204 through a neck unit 212. Neck unit 212 may have any suitable cross-sectional shape, including circular, elliptical, rectangular, and the like.

Head unit 202 may further comprise a drape 214, extending from the edges of head unit 202 to enclose a subject further from the environment and increase the size of head receiving opening 208. Drape 214 can be secured in place on or over head unit 202 by compression rings, zippers, fabric sleeves which slide over the frame components, Velcro and the like, or combinations thereof as would be appreciated by those of ordinary skill in the art. In one embodiment, drape 214 may be fabricated from materials including but not limited to plastics such as vinyl and nylon or combinations thereof. In one embodiment, drape 214 is disposable. In one embodiment, drape 214 is made out of a reusable plastic lining. In one embodiment, drape 214 may be made from a material that can be sterilized between each use.

In one embodiment, head unit 202 may be fabricated from a variety of materials now known and later developed such as steel, PVC pipe, aluminum, plastics, carbon fiber composite, other metals and the like, alone or in combination, to create a suitably robust and lightweight head unit 202.

In one embodiment, head unit 202 may be collapsible for easy storage and transport. However, as will be recognized by those of ordinary skill in the art, based on the teachings herein, drape 214 is equally usable with head units that are not collapsible, and/or head units that are mountable or otherwise fixedly securable to a bed frame, a gurney, a stretcher, a wall, a ceiling, an ambulance or the like.

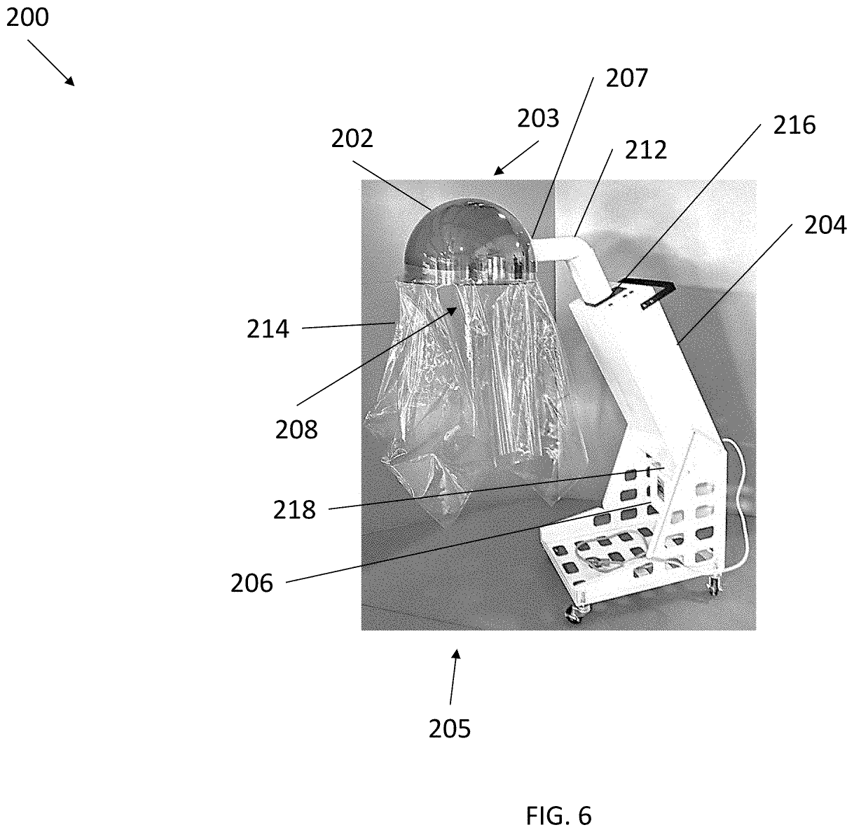

In one embodiment, neck unit 212 conveniently extends upwardly and forwardly to position head unit 202 for receiving the head or body of a subject (FIG. 6). In one embodiment, neck unit 212 is conveniently adjustable in a vertical direction and is secured in a preselected position as by a collar. The collar is set in place by a set screw, wherein this set screw passes through neck unit 212 and hence allows clamping it at different vertical position. In this manner, neck unit 212 and head unit 202 may be raised out of position when the subject is to be seated, and then lowered to an operative position whereby the subject may have her head substantially encircled by head unit 202. In one embodiment, head unit 202 is adjustably pivoted to neck unit 212 by a pivot joint, thereby allowing adjustment of the angle of head unit 202 in respect to neck unit 212.

In another exemplary embodiment, neck unit 212 may comprise a lifting column securely attached to a ceiling or overhead beam and is provided with a telescopic mechanism, configured to extend a few inches or several feet. In this manner, neck unit 212 and head unit 202 may be lowered down when the subject is seated or laid down.

From the above it is apparent that head unit 202 is freely adjustable relative to the head or body of the subject and that it can be readily adjusted for tilt, for forward and backward movement and for elevation to suit the convenience and comfort of the subject at any time either by the subject herself or by someone else.

Base unit 204 comprises a hollow unit comprising a first opening 216, a second opening 217 and at least one blower and a motor. Base unit 204 is proximally connected to neck unit 212 through first opening 216 and distally connected to filter box 206 through second opening 217. In one embodiment, base unit 204 may be connected to at least one neck unit 212 and head unit 202.

In one embodiment the at least one blower powered by the motor is configured to provide sufficient suction to generate a desired total airflow. The at least one blower is configured to draw air from the outside of head unit 202 and pass it through neck unit 212 towards base unit 204. Similar to blower 108, the blower can include but is not limited to a direct drive, forward curve centrifugal-type fan and a motor. In some embodiments, the blower is configured to move up to from about 50 cubic feet of air per minute (CFM) to about 150 CFM, such as about 110 CFM. The blower can have a diameter of between about 2.5 inches to about 12 inches, such as about 8 inches, and an axial length of between about 1 inch to about 3 inches. In some embodiments, the blower rotates between approximately 500 RPM and 5000 RPM, such as about 3200 RPM. In some embodiments, the blower can be driven between about 1/100 to 1/40 horsepower, such as about 1/70 horsepower.

In one embodiment, this continuous airflow powered by the at least one blower prevents the escape of any contaminated particles to the environment outside head unit 202. In one embodiment, the at least one blower and the motor can be powered by a main power lead. In another embodiment, the at least one blower and the motor can be powered by a rechargeable or replaceable battery.

Base unit 204 may further comprise a shutter respectively associated with at least one blower. The shutter is placed on first opening 216 and is adapted to seal an outflow of the at least one blower against inflow of air when the at least one blower is not in operation. The shutter may be mounted to deflect outwardly in an outflow from a blower, but to be biased to close sealingly in the absence of said outflow.

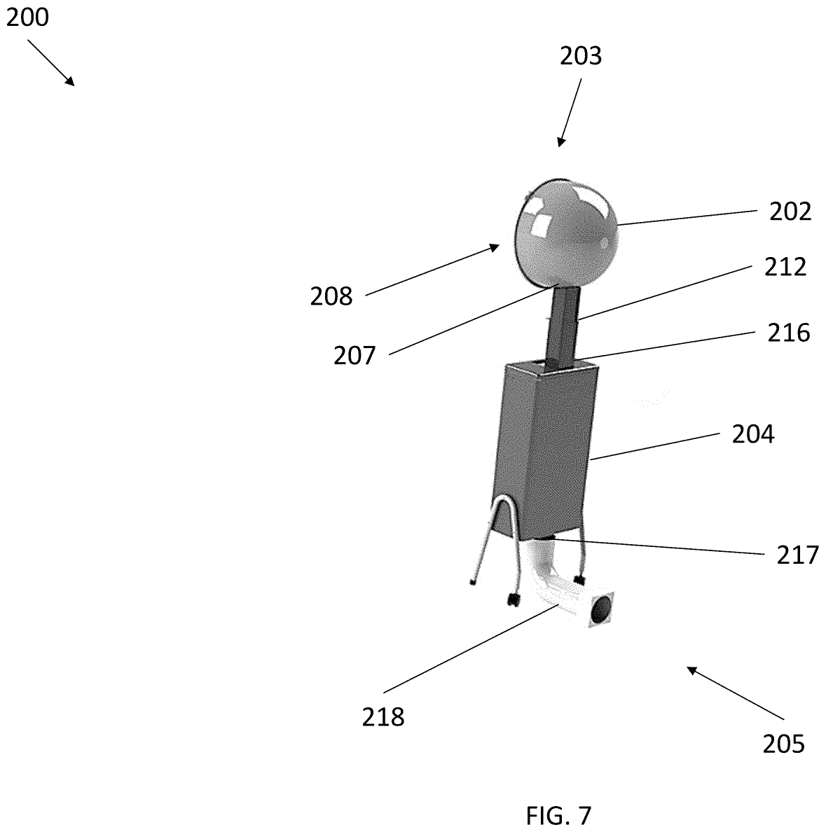

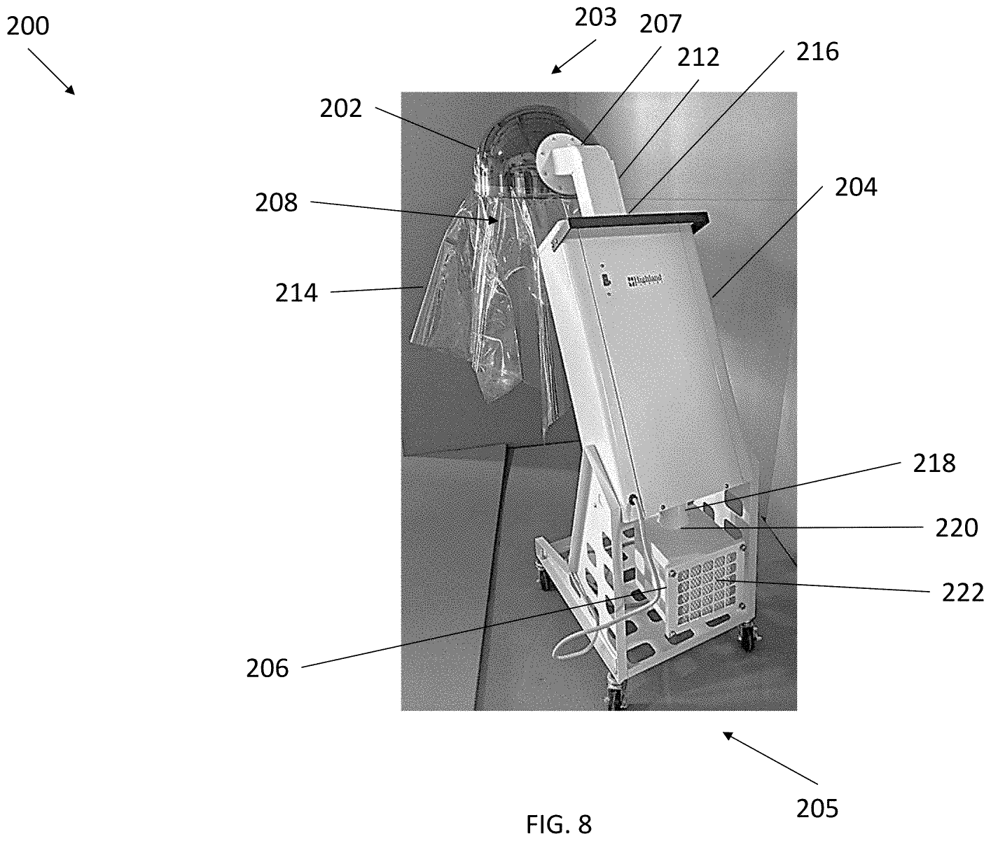

Referring to FIG. 7 and FIG. 8, base unit 204 may further comprise plurality of wheels, casters, bearings or other devices for rolling, sliding or otherwise transporting air-vent device 210. In one embodiment, casters have locking mechanism to allow fixing air-vent device 210 in position. In one embodiment, base unit 204 is not connected to wheels, casters, bearings or other devices, rather it is fixed in place. In one embodiment, base unit 204 may be mountable or otherwise fixedly securable to a bed frame, a gurney, a stretcher, a wheelchair, a wall, a ceiling, an ambulance or the like.

Base unit 204 is fluidly connected to filter box 206 through a connecting tube 218. Connecting tube 218 can have a diameter ranging between about 2 inches to about 6 inches, a length ranging between about 1 inch to about 3 feet, and can be made of materials selected from group including but not limited to steel, stainless steel, flexible aluminum and combinations thereof.

Filter box 206 comprises a first opening 220, at least one filter and an exhaust opening 222 and is enclosed on all other four sides. Base unit 204 outputs airflow coming from the at least one blower, goes through second opening 217, connecting tube 218 and from first opening 220 to filter box 206. The air exiting the at least one filter, then exits air-vent device through exhaust opening 222 into the environment.

In one embodiment, filter box 206 may be configured to act as an air diffuser to slow down the air flow containing contaminants and particles and prevent them from hitting directly on the at least one filter. For this reason, Filter box 206 may comprise a volume of empty space before the at least one filter. In such an embodiment, filter box 206 has a width and height of about 6 inches and a length of about 10 inches. However, one skilled in art would understand that any other applicable dimensions can be used for filter box 206. In one embodiment, the at least one filter, divides filter box 206 into a first chamber and a second chamber. First chamber comprises of mostly empty space to allow air to slow down before hitting the at least one filter. In one embodiment, the second chamber comprises at least one filter. In one embodiment, the at least one filter may be placed in the second chamber using a frame. In one embodiment, the at least one filter is placed at a distance of between about 2 inches and 8 inches from first opening 220.

It will be appreciated that it is possible to place a prefilter within filter box 206 to substantially cover the area of air inlet through first opening 220. In one embodiment, a prefilter is placed in the first chamber.

As described elsewhere herein, any suitable filter may be placed inside filter box 206, such as a replaceable HEPA filter and/or ULPA filter. In one aspect, filter box 206 may comprise a single or a combination of filters and not limited to HEPA or other passive Filters, Activated carbon Filters, washable filters, membrane filters, nanospun filters, non-woven filters, washable filters and any other filtration mediums configured to remove particulates, particulates, or other pollutants of different particle sizes and properties. Washable filters have the advantage of a long lifespan that can be renewed by washing or other processing of the filter. Further, washable filters have higher pressure drop, but are balanced by using newer technologies of washable filters. In another embodiment, all these filter cartridges are replaceable.

In one configuration of device 200 of the present invention, the HEPA filter and Activated carbon filter are packaged as separate filters. Alternatively, they are packaged as a single filter cartridge that combines the air filtration properties of both. Different combinations of filters are also contemplated within the scope of the present invention. These filters are replaceable within device 200. The HEPA filter and activated carbon filters function to remove different sized particles from the air. HEPA removes larger particulates, while the activated carbon is capable of adsorbing smaller particles including toxic chemical gases, some viruses, bacteria and more.

Different combinations or choices of filter mediums may be designed to be particularly efficient in removing selections of airborne agents, including viruses, and microbial antigens, toxins and allergens. One example may be for health conditions that are commonly triggered by particular airborne agents. Asthma, for instance, may be triggered by particulate matter such as pet dander, or pollen, more than by gaseous matter. Accordingly, a doctor, or consumer may select a filter suited to a particular trigger to symptoms of their ailment. Alternatively, a filter may be designed for a particular environment.

In one embodiment, the activated carbon filters are treated in different ways before use to improve their ability to filter different air pollutants. Different combinations of activated carbons may also be integrated into the filter, to the same effect. One particular example may be for health conditions that are commonly triggered by particular pollutants. Asthma, for instance, may be triggered by particulate matter such as pet dander, or pollen, more than by gaseous matter. Accordingly, a doctor, or consumer may select a filter suited to a particular trigger to symptoms of their ailment.

In one embodiment, filter box 206 may further comprise decontamination means such as a UV source, a disinfecting gas source or any other decontamination means known to one skilled in the art. In one embodiment, decontamination means can be placed in the first chamber.

In one embodiment, device 200 further comprises at least one sensor to measure a local airflow velocity at a point in an outflow of the filter in the second chamber. In one embodiment, at least one sensor may be positioned to measure the local airflow velocity at a preselected representative point in the inflow of the air. In one embodiment, the at least one sensor can be positioned anywhere within device 200 to measure changes in velocity. In one embodiment, the at least one sensor may comprise a runtime meter. Such runtime indication may allow the at least one filter to be changed or cleaned based on the actual accumulated runtime of operation of air-vent device 10 (i.e., time during which air is actually passing through the at least one filter), rather than relying on a calendar period of time.

In one embodiment, device 200 comprises a plurality of alarms configured to indicate when the overall volumetric flow through device 200 falls below a predetermined safety level. In one embodiment, device 200 further comprises a display unit configured to display data including the overall volumetric flow through device 200.

The components of the air-vent devices of the present invention can be constructed from any suitable material. For example, curtain frames can be constructed from fiberglass rods, blower units can be constructed from powder-coated steel sheet metal, stands can be constructed from aluminum, and bases can be constructed from tubular steel. The components and systems can be made using any suitable method known in the art. The method of making may vary depending on the materials used. For example, devices substantially comprising a metal may be milled from a larger block of metal or may be cast from molten metal. Likewise, components substantially comprising a plastic or polymer may be milled from a larger block, cast, or injection molded. In some embodiments, the devices may be made using 3D printing or other additive manufacturing techniques commonly used in the art.

### Method of Use

The present invention provides a method for removing contaminates and other particulate matter from the air around a subject having a microbial infection, suspected of having a microbial infection, or suspected of being a carrier of a microorganism. The present invention has particular application to reducing cross-contamination caused by a harmful biological substance. Further, the present invention provides a method for ventilating and cleaning the air and minimizing the risk of microorganisms, viruses or any other health hazardous airborne matter to dissipate from one person to other persons. The present invention may also be useful in removing airborne contaminates which are not particularly harmful to humans, but instead are merely considered to be a nuisance. Examples include dust and pollen which may produce an allergic or even asthmatic reaction. Those skilled in the art can appreciate that other objects or areas may be contained using the invention.

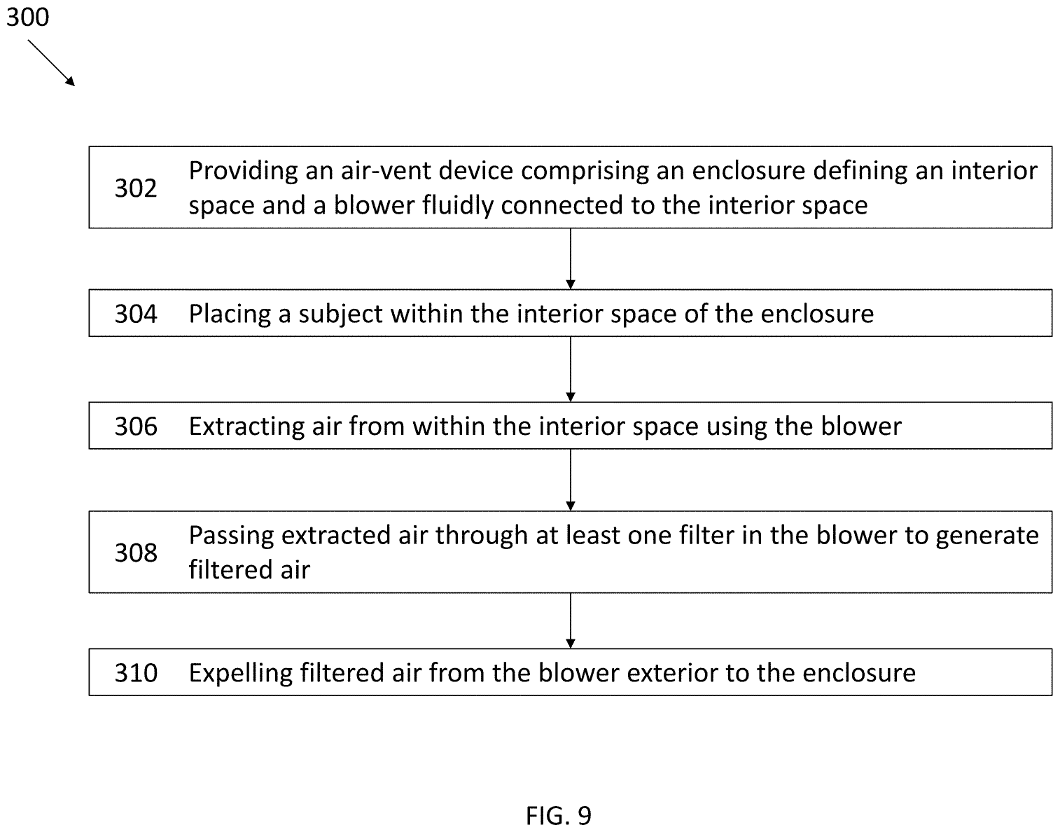

Referring now to FIG. 9, an exemplary method 300 of using an air-vent device to remove airborne contaminants surrounding a subject is depicted. Method 300 begins with step 302, wherein an air-vent device is provided, the air-vent device comprising an enclosure defining an interior space and a blower fluidly connected to the interior space. In step 304, a subject is placed within the interior space of the enclosure. In various embodiments, the subject is positioned such that aerosols and particulates associated with breathing, talking, speaking, singing, coughing, sneezing, and the like are exhaled or expelled within the interior space of the enclosure. In step 306, air from within the interior space is extracted using the blower. In step 308, extracted air is passed through at least one filter in the blower to generate filtered air. In step 310, filtered air is expelled from the blower exterior to the enclosure.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. An air-vent device comprising:
a stand extending vertically between a superior end and an inferior end;
an enclosure positioned at the superior end of the stand, the enclosure having an interior space bounded by a generally closed top and lateral side and an open bottom side; and
a blower having an inlet port and an exhaust port, the inlet port being fluidly connected to the interior space of the enclosure;
wherein the blower comprises one or more filters between the inlet port and the exhaust port.

2. The device of claim 1, wherein the stand has an adjustable height.

3. The device of claim 1, wherein the enclosure is suspended from a frame extending from the superior end of the stand.

4. The device of claim 3, wherein the enclosure is attached to the frame by connectors selected from the group consisting of: rubber rings, ties, clips, cables, rubber bands, hooks, and loops.

5. The device of claim 1, wherein the stand comprises wheeled legs at the inferior end.

6. The device of claim 1, wherein the stand further comprises a control unit configured to power and operate the blower.

7. The device of claim 1, wherein the blower is configured to move between about 50 cubic feet of air per minute (CFM) to about 150 CFM.

8. The device of claim 1, wherein the blower has a fan speed between about 500 revolutions per minute (RPM) and about 5000 RPM.

9. The device of claim 1, wherein the one or more filters are selected from the group consisting of: high-efficiency particulate air (“HEPA”) filters, ultra-low particulate air (“ULPA”) filters, activated carbon filters, washable filters, membrane filters, nanospun filters, and non-woven filters.

10. The device of claim 1, wherein the lateral side of the enclosure comprises one or more access slots.

11. The device of claim 10, wherein the access slots are slits formed in the enclosure.

12. The device of claim 10, wherein the access slots are apertures formed in the enclosure.

13. The device of claim 10, wherein each access slot is covered by a flap.

14. The device of claim 1, wherein the enclosure has a height between about 3 feet and about 10 feet.

15. The device of claim 1, wherein the enclosure has a width or diameter between about 2 feet and about 6 feet.

16. The device of claim 1, wherein the enclosure has a thickness between about 0.001 inches and about 0.024 inches.

17. The device of claim 1, wherein the enclosure is constructed from a material selected from the group consisting of: polyvinyl, polyethylene, polyvinylchloride, and polyester.

18. The device of claim 1, wherein the enclosure is sized to fit over a width of a hospital bed, a hospital gurney, a hospital stretcher, an ambulance stretcher, a chair, a bench, a wheelchair, an operating table, or an instrument tray.

19. A method for removing airborne contaminants surrounding a subject comprising the steps of:
providing an air-vent device comprising an enclosure defining an interior space and a blower fluidly connected to the interior space;
placing a subject within the interior space of the enclosure;
extracting air from within the interior space using the blower;
passing extracted air through at least one filter in the blower to generate filtered air; and
expelling filtered air from the blower exterior to the enclosure.

20. The method of claim 19, wherein the subject is positioned such that aerosols and particulates associated with breathing, talking, speaking, singing, coughing, or sneezing are exhaled or expelled within the interior space of the enclosure.
